(19) United States
(12) Patent Application Publication
(10) Pub. No.: US 2026/0093964 A1
(43) Pub. Date: Apr. 2, 2026

(54) BLOCK-BASED COMPRESSION OF NEURAL NETWORK DATA

(71) Applicant: ADVANCED MICRO DEVICES, INC., Santa Clara, CA (US)

(72) Inventor: Navin Patel, Wesley Chapel, FL (US)

(21) Appl. No.: 18/901,476

(22) Filed: Sep. 30, 2024

(51) Int. Cl. G06N 3/0495

(52) U.S. Cl. CPC G06N 3/0495

(57) ABSTRACT

A processing system reduces the amount of memory and bandwidth needed to store and access trained neural network data (e.g., trained weights) while maintaining fidelity to the original data by patterning the data into two-dimensional (2D) blocks, converting the data into color data (e.g., monochrome or red, blue, green (RGB) data), and applying block compression to the color data. The compressed data is stored with header information indicating the conversion to color data and block compression algorithm that was used to compress the color data. When a processor subsequently accesses the compressed color data, the processor decompresses the color data and converts the color data back into the original format of the neural network data for application to new inputs during the inference phase.

### BACKGROUND

Neural networks are employed in a wide variety of applications, including image recognition and classification, game engine design, medical imaging and analysis, and many others. As artificial intelligence and neural networks have advanced, the amount of data consumed and generated by those neural networks has significantly increased. For example, the number of parameters used to characterize Large Language Models (LLMs) can range from a few million parameters to several billion. The parameters include weights that are trained during a training phase, after which the weights are stored at an internal or external memory. The trained weights are subsequently accessed for application during an inference phase. The growth in the number of parameters defining LLMs and other machine learning models requires increased memory to store the parameters as well as increased bandwidth to access the parameters.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that compresses neural network data using color block compression in accordance with some embodiments.

FIG. 2 is a diagram illustrating weights associated with layers of neurons in a neural network patterned into blocks in accordance with some embodiments.

FIG. 3 is a diagram illustrating selective addition of padding to a block of neural network data in accordance with some embodiments.

FIG. 4 is a block diagram illustrating components of a processing system patterning neural network data into blocks, converting the neural network data into color data, and compressing the color data using block compression in accordance with some embodiments.

FIG. 5 is a flow diagram illustrating a method for compressing neural network data using color block compression in accordance with some embodiments.

FIG. 6 is a flow diagram illustrating a method for decompressing neural network data in accordance with some embodiments.

### DETAILED DESCRIPTION

Each neuron in each layer of a neural network is associated with a number of inputs having values between zero and one that represent information such as color or text. Each neuron performs a gradient calculation based on the input(s) times a weight plus a bias. If the gradient calculation meets a threshold, the neuron activates and transfers its value to a neuron in the next layer of the network. During a training phase, the weights are trained (i.e., adjusted) and stored at a memory. During an inference phase, the trained weights are accessed from the memory and applied to new inputs. For complex inference models, the number of weights can reach into the billions, thus consuming a large amount of space in memory and a significant amount of bandwidth to store and subsequently access the trained weights.

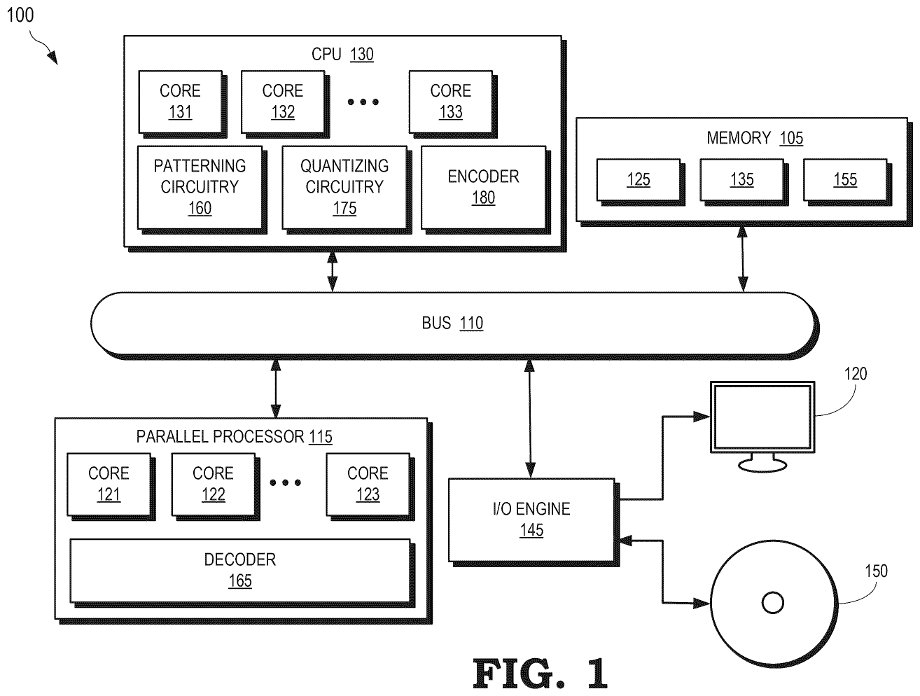

FIGS. 1-6 illustrate techniques for reducing the amount of memory and bandwidth needed to store and access trained neural network data (e.g., trained weights) while maintaining fidelity to the original data by patterning the data into two-dimensional (2D) blocks at a processing system, converting the data into color data (e.g., monochrome or red, blue, green (RGB) data), and applying block compression to the color data. The compressed data is transmitted to a memory for storage with header information indicating the conversion to color data and block compression algorithm that was used to compress the color data. When a processor subsequently accesses the compressed color data from the memory, the processor decompresses the color data and converts the color data back into the original format of the neural network data for application to new inputs during the inference phase.

The processing system patterns the neural network data for each layer of the neural network data into 2D matrices (blocks) of pixels. In some implementations, the processing system maps each layer of the neural network data to a single 2D matrix such that each weight represents a pixel. In other implementations, the processing system maps each layer of the neural network data to multiple 2D matrices representing color channels, such that each weight represents a value of one of, e.g., a red, green, blue, or alpha channel.

The processing system quantizes the neural network data by converting the block patterned neural network data (e.g., weights) into color data. The neural network data is originally stored in a floating point 32-bit (fp32) or a floating point 16-bit (fp16) data format, and in some implementations, the processing system quantizes the weights by converting them to integer values (e.g., 4, 5, 6, or 8-bit integers). In other implementations, the processing system converts original fp16 data to half-float 16-bit data, and in yet other implementations, the processing system converts the original fp32 or fp16 data to RGB color data by, for example, multiplying the original fp32 or fp16 data by 255.

Various block compression formats have been developed, including a set of seven standard formats called BC1 through BC7. These formats are widely used in other contexts, for example, realistic 3D games to reduce memory use (storage and bandwidth) of texture maps. The texture compression enabled by all the BCn formats is based on block compression, and more specifically, 4×4 blocks of pixels. Thus, in some implementations, after patterning the neural network data into 2D blocks, a processor selectively adds padding to the 2D blocks of data to format the blocks into integer multiples of 4×4 blocks that are amenable to compression using any of the BCn formats.

Once the neural network data has been patterned and padded into 4×4 blocks (or multiples of 4×4 blocks up to, e.g., 12×12 blocks) and quantized, the processing system performs block compression on each block using a block compression algorithm such as BC1 through BC7. In many cases, very limited color variation exists within a given block. For example, blocks may contain shades of a single color or a gradient between two colors. The BCn formats exploit this fact by separating the definition of the colors in a block from their spatial distribution. Thus, rather than storing, e.g., a 1-byte color component for each pixel of a 16-pixel block (which would require 16 bytes), BCn block compression techniques compress 4×4 blocks of pixels into a single (smaller) data packet. Generally, this involves selecting two or more (depending on the BC compression type) “endpoint” colors of, e.g., 1 byte each, with some information per-pixel (referred to as an index) about how to blend between those two colors at each pixel. For example, the BC4 compression format stores two colors and 16 3-bit indices that are used to interpolate the original colors in the texture for each pixel in the block. In this way, the uncompressed 16-byte color information for the block is compressed to 8 bytes (2 bytes for color information and 16×3 bits=48 bits=6 bytes for index information).

The different BC types mostly differ in how many texture channels they have. For example, some BCn formats include compression of an alpha channel of an RGBA (red, green, blue, alpha) input pixel block that represents the transparency/opacity for a color. Whereas an uncompressed RGBA 4×4 pixel block requires 64 Bytes of data, a compressed texture block using BCn achieves a compression ratio of up to 8:1. BC6 and BC7 employ the concept of modes that decide the interpretation of each block. For the other BC modes all blocks are encoded the same way, with the same number of bits allocated for endpoint colors and blend values. With BC6 and BC7, different modes allocate their bits differently on a per-block basis, which allows the compressor to make different quality trade-offs in different regions of a texture (block of color data). Table 1 below illustrates the memory requirements and stored information for each of the BCn compression formats.

TABLE 1

| BC format | Memory | | Color/alpha | Indices |
|---|---|---|---|---|
| BC1 | 8 | bytes | Color0, color1 | 16 indices |
| BC2 | 16 | bytes | 16 alpha values, color0, color1 | 16 indices |
| BC3 | 16 | bytes | Alpha0, alpha1 color0, color1 | 16 indices |
| BC4 | 8 | bytes | Red0, red1 | 16 indices |
| BC5 | 16 | bytes | Green0, green1 | 16 indices |
| BC6 | 16 | bytes | Color0, color1 mode dependent | Up to 3 sets |
| | | | | of indices |
| BC7 | 16 | bytes | Color0, color1 mode dependent | Up to 3 sets |
| | | | | of indices |

BCn compression therefore reduces a 4×4 texture with 16 RGBA pixel values having a total of 64 Bytes to either 8 Bytes (in the case of BC1 and BC4) or 16 Bytes (in the case of BC2, BC3, BC5, BC6, and BC7). The processing system transmits the block-compressed color data representations of the neural network data, with header information indicating the quantization method and which block compression algorithm was used to compress the color data, for storage at a memory for subsequent access and decoding back to 4×4 gradient values with some quantization losses.

In some implementations, the processing system performs the block patterning, selects a quantization method, and selects a BCn compression format based on a programmable quality factor (also referred to herein as a quality setting) that specifies an acceptable quantization loss associated with compressing the neural network data. The processing system also preconditions block-compressed texture blocks by separately streaming color components and index components for lossless compression in some implementations. Converting the neural network data to color data and compressing the color data using block compression facilitates 4× to 8× compression of neural network data within a programmable quantization loss. The processing system thereby saves significant memory and bandwidth resources while allowing the inference model to maintain accurate predictions.

FIG. 1 is a block diagram of a processing system 100 that patterns neural network data into blocks, converts the neural network data to color data, and applies block compression to the color data in accordance with some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory since it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The processing system 100 also includes one or more parallel processors 115 (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). In some implementations of the processing system 100, the parallel processor 115 is implemented as a graphics processing unit (GPU) that renders images for presentation on a display 120. For example, the GPU renders objects to produce values of pixels that are provided to the display 120, which uses the pixel values to display an image that represents the rendered objects. The parallel processor 115 implements a plurality of processor cores 121, 122, 123 (collectively referred to herein as “the processor cores 121-123”) that execute instructions concurrently or in parallel. The number of processor cores 121-123 implemented in the parallel processor 115 is a matter of design choice and some implementations of the parallel processor 115 include more or fewer processor cores than shown in FIG. 1. Some implementations of the parallel processor 115 are used for general purpose computing. The parallel processor 115 executes instructions such as program code 125 stored in the memory 105 and the parallel processor 115 stores information in the memory 105 such as the results of the executed instructions.

The processing system 100 also includes a central processing unit (CPU) 130 that is connected to the bus 110 and therefore communicates with the parallel processor 115 and the memory 105 via the bus 110. The CPU 130 implements a plurality of processor cores 131, 132, 133 (collectively referred to herein as “the processor cores 131-133”) that execute instructions concurrently or in parallel. The number of processor cores 131-133 implemented in the CPU 130 is a matter of design choice and some implementations include more or fewer processor cores than illustrated in FIG. 1. The processor cores 131-133 execute instructions such as program code 135 stored in the memory 105 and the CPU 130 stores information in the memory 105 such as the results of the executed instructions. The CPU 130 is also able to initiate graphics processing by issuing draw calls to the parallel processor 115. Some implementations of the CPU 130 implement multiple processor cores (not shown in FIG. 1 in the interest of clarity) that execute instructions concurrently or in parallel.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the GPU 115, or the CPU 130. In the illustrated implementation, the I/O engine 145 reads information stored on an external storage component 150, which is implemented using a non-transitory computer readable medium such as a compact disk (CD), a digital video disc (DVD), and the like. In some implementations, the external storage component 150 is external to the processing system 100 (e.g., the external storage component 150 is implemented in the cloud). The I/O engine 145 is also able to write information to the external storage component 150, such as the results of processing by the parallel processor 115 or the CPU 130.

In some implementations, the CPU 130 and/or the parallel processor 115 include portions of a codec that compresses and/or decompresses neural network data 155 stored at the memory 105, texture and other image data. The neural network data 155 includes trained weights used in machine learning applications. In the illustrated example, the CPU 130 includes patterning circuitry 160, which patterns the neural network data 155 into 2D blocks, quantizing circuitry 175, which converts the neural network data 155 into color data, and an encoder 180, which applies block-based compression such as BCn compression to the color data to form block-compressed color data for storage at the memory 105 or at the external storage component 150 as color data in the form of blocks, referred to herein as compressed color blocks.

Each of the patterning circuitry 160, quantizing circuitry 175, and the encoder 180 is hardware circuitry designed and configured to perform the corresponding operations described herein. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In other embodiments, each of the patterning circuitry 160, quantizing circuitry 175, and the encoder 180 is a set of instructions (e.g., software) executed at, for example, the processor cores 131-133 or 121-123, such that, when executed, the processor cores 131-133 or 121-123 perform the operations described herein.

The patterning circuitry 160 groups the neural network data 155 by patterning the trained weights (not shown) for each layer of the neural network data 155 into 2D matrices (blocks) of pixels (i.e., 2D arrays of elements). In some implementations, the patterning circuitry 160 maps the trained weights associated with each layer of the neural network data to a single 2D matrix such that each weight represents a single RGB pixel of the 2D matrix. In other implementations, the processing system maps each layer of the neural network data to a 2D matrix representing a color channel, such that each weight represents a value of one of, e.g., a red, green, blue, or alpha channel.

In some cases, when the floating-point values of the trained weights that have been arranged into the 2D matrices are converted into monochrome or RGB color values, patterns in the data are visible, indicating that the values are compressible using color block compression techniques. In other cases, in which such patterns are not visible, an editor (not shown) rearranges the neurons to place their associated trained weights into pixels of one or more 2D matrices to generate a compressible block while maintaining a mapping to the original locations of the neurons.

The quantizing circuitry 175 converts the floating-point values of the trained weights into color values using one of a variety of approaches. For example, if the trained weight is an fp16 or fp32 value, in some implementations the quantizing circuitry 175 converts the floating-point value to an 8-bit or 6-bit or 5-bit or 4-bit single integer value by, e.g., multiplying the floating-point value by 255. In other implementations, the quantizing circuitry 175 places the floating-point value into one of the red, blue, green, or alpha channels without further conversion (i.e., fp16 to half-float 16-bit). In such implementations, there is no loss in precision associated with the color conversion. In yet other implementations, the quantizing circuitry 175 converts the floating-point value to an RGB value using another algorithm.

In some embodiments, the quantizing circuitry 175 selects the conversion technique based on an acceptable loss indicated by a programmable quality factor (not shown). The quantizing circuitry 175 indicates the conversion technique used to convert the floating-point values of the trained weights to color values in a header associated with each 2D matrix. When the compressed data is subsequently accessed, the decoder 165 employs a reverse conversion process based on the conversion technique indicated in the header to convert the color data back into floating-point values of the trained weights.

The encoder 180 applies block-based compression such as BCn compression to each 2D matrix (block) to form block-compressed data. In some implementations, the CPU 130 transmits the block-compressed data for storage at the memory 105 or at the external storage component 150, where the data is stored as color data in the form of blocks, referred to herein as compressed color blocks. Each compressed color block includes both color component and index component information for a block of pixels of a 2D matrix that has been compressed using a block compression algorithm such as a BCn compression format.

In some implementations, after forming the compressed color blocks, the encoder 180 conditions the compressed color blocks by dividing each compressed color block into two segments: one segment includes the color component(s) and the other segment includes the index components. The encoder 180 separately transmits the color components and the index components in streams to a lossless compressor (not shown) for further lossless compression. For example, in some implementations, the encoder 180 streams the color components for compressed color blocks of a 2D matrix from left to right and from top to bottom into a block of memory and separately streams the corresponding index components for the compressed color blocks of the 2D matrix from left to right and from top to bottom into a separate block of memory. The encoder 180 then groups color components and index components for adjacent compressed color blocks into tiles to enhance further compressibility of the compressed texture blocks by the lossless compressor. Such tiling takes advantage of patterns of color component data that span multiple rows of compressed color blocks, allowing the lossless compressor to achieve a higher compression ratio than what is attainable when the compressed color blocks are individually losslessly compressed. The encoder 180 indicates the groupings in a stream header for each of the color component and index component streams in some implementations. For example, the stream header indicates an offset (starting point), width (number of blocks horizontally), height (number of blocks vertically), and stride for each grouping of color components and each grouping of index components that are to be collectively compressed as a group by the lossless compressor.

Each of the BCn compression formats is associated with a loss, ranging from a minimal loss (e.g., using BC6 with a low-loss mode) to a relatively high loss (e.g., using BC1). In some implementations, the encoder 180 selects a BCn compression format based on the programmable quality factor, which specifies an acceptable quantization loss associated with compressing the neural network data.

The cores 121-123 in the parallel processor 115 perform operations using the neural network data 155 stored in the memory 105 or in the external storage component 150. In some implementations, the cores 121-123 or the parallel processor 115 implement caches to cache portions of the neural network data 155 that are frequently used by one or more of the cores 121-123. In some embodiments, the parallel processor 115 performs machine learning operations such as neural network convolutions using the neural network data 155.

The parallel processor 115 further includes a decoder 165 to decompress the compressed color data and convert the color data back into the original format of the neural network data 155. For implementations for which the encoder 180 performs conditioning of the compressed color blocks as described above, the decoder 165 performs lossless decompression on the losslessly compressed groupings of color components and index components. The decoder 165 then performs post-conditioning by merging the decompressed groupings of color components and index components before decompressing the compressed color data and converting the color data back into the original format of the neural network data 155 and unmapping the neural network data 155 from the one or more 2D matrices.

Similar to the patterning circuitry 160, quantizing circuitry 175, and the encoder 180, the decoder 165 is hardware circuitry designed and configured to perform the corresponding operations described herein. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In other embodiments, the decoder 165 is a set of instructions (e.g., software) executed at, for example, the processor cores 121-123, such that, when executed, the processor cores 121-123 perform the operations described herein.

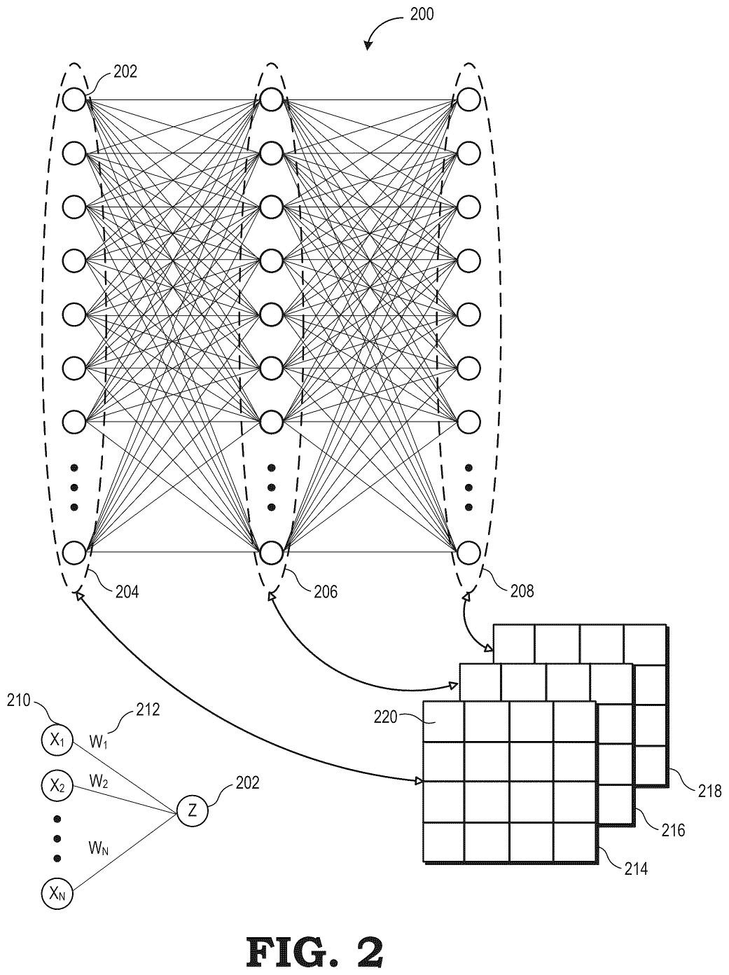

FIG. 2 is a diagram illustrating weights associated with layers 204, 206, 208 of neurons 202 in a neural network 200 patterned into blocks 214, 216, 218 in accordance with some embodiments. Each neuron 202 calculates z=b+Σwx, where b is a constant bias, w is a weight 212, and x is an input 210. When z equals a threshold value, the neuron 202 activates and provides its value to a neuron in the next layer of the neural network. The patterning circuitry 160 of the processing system 100 patterns the weights 212 associated with each neuron 202 into the blocks 214, 216, 218.

In some implementations, the patterning circuitry 160 assigns each weight 212 to a pixel 220 of a block 214, 216, 218 for conversion of the floating-point value of the weight 212 to a monochrome or RGB color value. In other implementations, the patterning circuitry 160 assigns each layer 204, 206, 208 of neurons 202 to a different color channel (e.g., a red channel, a green channel, a blue channel, and an alpha channel), each color channel corresponding to a block 214, 216, 218. Associating each block 214, 216, 218 with a different color channel yields a lower loss than populating each block 214, 216, 218 with RGB pixels. Accordingly, in some implementations, the patterning circuitry 160 selects a patterning technique based on the programmable quality factor.

In order for the patterned 2D matrices to be compressible using a block compression format such as BCn, the dimensions of the 2D matrices must be a multiple of 4×4 elements (i.e., 16 elements arranged in a square 4×4 block). If the width and height of a 2D matrix of trained weights is not divisible by 4×4, the patterning circuitry 160 selectively adds zero-value pixels to the 2D matrix until the width and height of the 2D matrix is evenly divisible by 4×4.

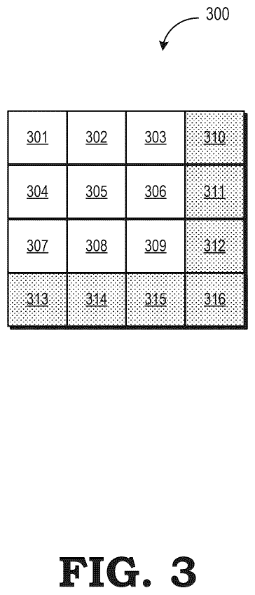

FIG. 3 is a diagram illustrating selective addition of padding to a block 300 of neural network data in accordance with some embodiments. The block 300 is a 3×3 2D matrix of trained weights arranged in pixels 301-309. Because the 2D matrix is not divisible by 4×4, the patterning circuitry 160 adds pixels 310-316 (i.e., an additional row and an additional column of pixels), having values of zero. The zero-value pixels 310-316 function as padding to bring the 2D matrix into a 4×4 format that is compressible using a BCn block compression format. In other examples, the patterning circuitry 160 adds a different number of rows and/or columns of padding to form a 2D matrix that is evenly divisible by a 4×4 block of pixels (e.g., adding 1 row and 3 columns to an 11×9 2D matrix of trained weights).

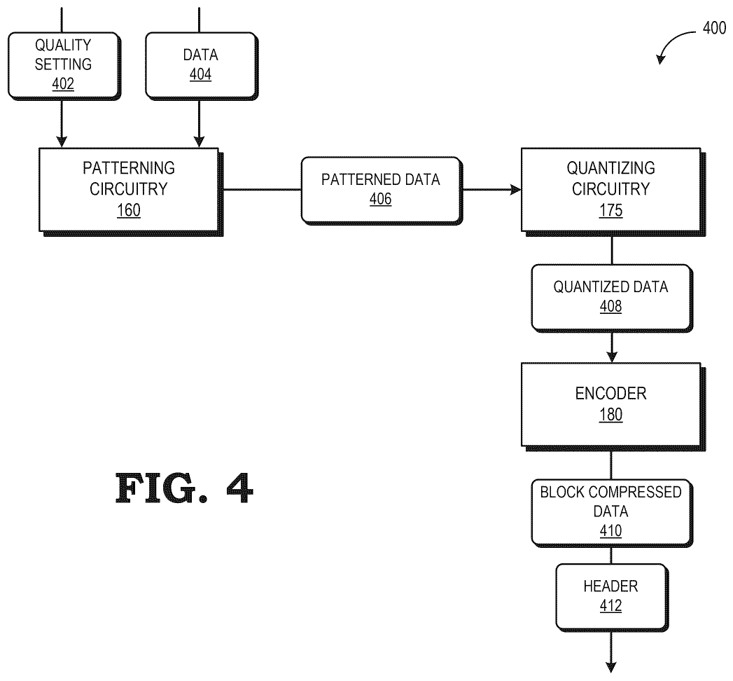

FIG. 4 is a block diagram 400 illustrating components of the processing system 100 patterning neural network data 404 into blocks, converting the neural network data 404 into quantized color data 408, and compressing the color data 408 using block compression into block compressed data 410 in accordance with some embodiments. In the illustrated example, the patterning circuitry 160 accesses a programmable quality setting 402 and neural network data 404 such as floating-point values of trained weights associated neurons of a neural network. The patterning circuitry 160 arranges the neural network data 404 into 2D matrices of patterned data 406. In some implementations, the patterning circuitry 160 places a trained weight into each pixel of a 2D matrix, and in other implementations, the patterning circuitry 160 places the weights associated with the neurons of each layer of the neural network into 2D matrices corresponding to each of a red, green, blue, and alpha channel. If the dimensions of a 2D matrix of patterned data 406 are not an integer multiple of 4×4 pixels, the patterning circuitry 160 selectively adds padding (i.e., zero value pixels) to the margins of the 2D matrix to generate a 2D block of data that is evenly divisible by 4×4 pixels.

The patterned data 406 is accessed by the quantizing circuitry 175, which converts the floating-point values of the trained weights into monochrome or color data. In some implementations, the quantizing circuitry 175 converts fp16 or fp32 trained weight data into 8-, 6-, 5-, or 4-bit color data. In other implementations, e.g., if the trained weights are in fp16 format and if the encoder 180 applies a BC6 block compression format, the quantizing circuitry 175 leaves the fp16 values as is, without performing further quantization. In yet other implementations, the quantizing circuitry 175 converts the floating-point trained weight values to RGB color values. The quantizing circuitry 175 selects a conversion algorithm based on the original format of the neural network data 404 (e.g., fp16 or fp32) and the programmable quality setting 402, and applies the selected conversion algorithm to produce quantized (color) data 408.

The encoder 180 accesses the quantized data 408 and applies a block compression format to compress the quantized data 408 into block compressed data 410. The encoder 180 selects a block compression format based on the format of the quantized data (e.g., half-float 16-bit data vs. 8-, 6-, 5-, or 4-bit data) and the programmable quality setting 402, which indicates an acceptable precision loss for compression of the neural network data 404. The encoder 180 includes a header 412 indicating any padding added by the patterning circuitry 160, the quantization conversion algorithm used by the quantizing circuitry 175, and the block compression format applied by the encoder 180 to compress the neural network data 404 into the block compressed data 410. The encoder 180 stores the block compressed data 410 and the header 412 at the memory 105 or the external storage component 150.

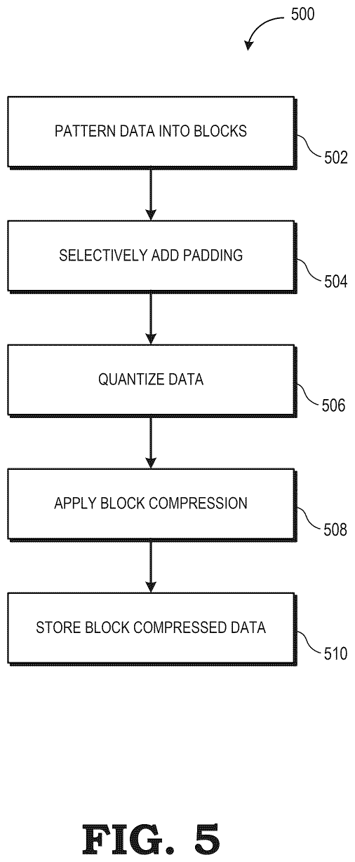

FIG. 5 is a flow diagram illustrating a method 500 for compressing neural network data using color block compression in accordance with some embodiments. In some embodiments, the method 500 is implemented in a processing system such as processing system 100.

At block 502, the patterning circuitry accesses neural network data such as neural network data 404 and a programmable quality setting such as quality setting 402. In some implementations, the neural network data 404 includes floating-point values of trained weights associated layers of neurons of a neural network. The patterning circuitry 160 groups the neural network data 404 into 2D blocks of patterned data 406. In some implementations, the patterning circuitry 160 places a trained weight into each element (i.e., pixel) of the 2D block. In other implementations, to minimize precision losses associated with patterning the neural network data into matrices, the patterning circuitry 160 places the trained weights associated with the neurons of each layer of the neural network into 2D matrices associated with each of a red, green, blue, and alpha channel. For example, the patterning circuitry 160 places the trained weights associated with the neurons of a first layer of the neural network into a 2D block 214 corresponding to a red channel, places the trained weights associated with the neurons of a second layer into a 2D block 216 corresponding to a green channel, places the trained weights associated with the neurons of a third layer into a 2D block 218 corresponding to a blue channel, and places the trained weights associated with the neurons of a fourth layer into a 2D block corresponding to an alpha channel.

At block 504, the patterning circuitry 160 selectively adds padding to the 2D blocks of patterned neural network data to form 2D blocks that have dimensions that are an integer multiple of 4×4 pixels. Thus, if the dimensions of a 2D matrix of patterned data 406 are not an integer multiple of 4×4 pixels, the patterning circuitry 160 selectively adds padding (i.e., zero value pixels) to the margins of the 2D matrix to generate a 2D block of data that is evenly divisible by 4×4 pixels and therefore amenable to block compression using a BCn block compression format.

At block 506, the quantizing circuitry 175 selects a quantization algorithm for converting the neural network data 404 into quantized color data 408. The quantizing circuitry 175 selects the quantization algorithm based on the original format of the neural network data 404 (e.g., fp16 or fp32) and the programmable quality setting 402, and applies the selected conversion algorithm to produce quantized data 408.

At block 508, the encoder 180 applies a block compression format such as BCn to the quantized data 408 to compress the neural network data 404 into block compressed data 410. The encoder 180 selects a block compression format based on the programmable quality setting 402 in some implementations. Depending on the block compression format selected by the encoder 180 and the quantization algorithm selected by the quantizing circuitry 175, the neural network data is compressible by a factor of up to, e.g., 32. The encoder 180 generates a header 412 indicating any padding added by the patterning circuitry 160, the quantization conversion algorithm used by the quantizing circuitry 175, and the block compression format applied by the encoder 180 to compress the neural network data 404 into the block compressed data 410. At block 510, the encoder 180 transmits the block compressed data 410 and the header 412 for storage at the memory 105 or the external storage component 150.

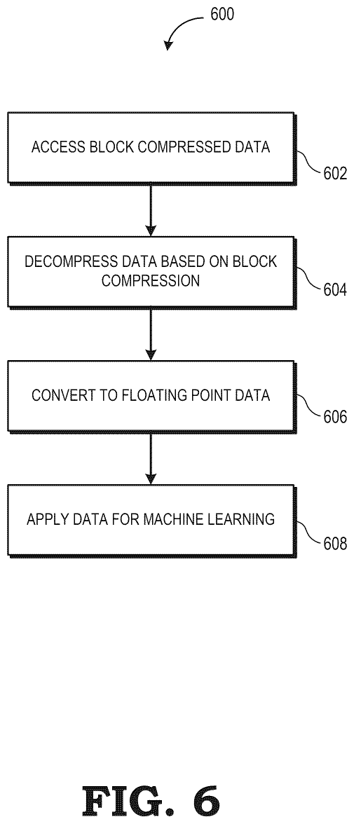

FIG. 6 is a flow diagram illustrating a method 600 for decompressing neural network data in accordance with some embodiments. In some embodiments, the method 600 is implemented in a processing system such as processing system 100. In some embodiments, the method 600 is implemented at a decoder 165 that is included in a parallel processor 115 of the processing system 100 and in other embodiments, the method 600 is implemented at a decoder 165 that is included in a processing system different from the processing system at which the neural network data 404 was compressed.

At block 602, the decoder 165 accesses the block compressed data 410 and the header 412 from the memory 105 or the external storage component 150. At block 604, the decoder 165 decompresses the block compressed data 410 based on the block compression format indicated at the header 412.

At block 606, the decoder 165 converts the decompressed color data into the original floating-point format of the neural network data 404 using the inverse of the quantization algorithm that was used by the quantizing circuitry 175 to convert the neural network data 404 into color data. At block 608, the parallel processor 115 applies the decompressed floating-point values of the trained weights for machine learning, such as by multiplying the trained weights by one or more inputs.

In some embodiments, the apparatus and techniques described above are implemented in a system including one or more integrated circuit (IC) devices (also referred to as integrated circuit packages or microchips), such as the processing system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
grouping neural network data into a plurality of blocks;
converting each block of neural network data into a block of color data; and
compressing the blocks of color data using block compression.

2. The method of claim 1, further comprising:
transmitting the compressed blocks of color data for storage at a memory.

3. The method of claim 1, wherein grouping the neural network data comprises assigning each layer of a plurality of layers of neural network data to one of a color channel or an alpha channel.

4. The method of claim 1, further comprising:
dividing each compressed block of color data into a color component and an index component; and
separately streaming color components and index components for a plurality of compressed blocks of color data for lossless encoding.

5. The method claim 1, further comprising:
indicating at a header of each compressed block of color data a block compression format that was used to compress the color data and an algorithm used to convert the block of neural network data into a block of color data.

6. The method of claim 1, wherein each block of the plurality of blocks comprises a two-dimensional array of elements.

7. The method of claim 6, further comprising:
selectively padding each two-dimensional array of elements to generate two-dimensional arrays of elements that are divisible by 4×4 elements.

8. The method of claim 1, further comprising:
specifying a quality factor to limit a quantization loss associated with compressing the neural network data.

9. The method of claim 8, further comprising:
selecting, based on the quality factor, at least one of a quantization algorithm for quantizing a floating-point value of neural network data and a format for the block compression.

10. A processing system, comprising:
at least one processor configured to:
group neural network data into a plurality of blocks;
convert the blocks of neural network data into blocks of color data; and
compress the blocks of color data using a block compression format for storage at a memory.

11. The processing system of claim 10, wherein the at least one processor is further configured to:
assign each layer of a plurality of layers of neural network data to one of a color channel or an alpha channel.

12. The processing system of claim 10, wherein the at least one processor is further configured to:
divide each compressed block of color data into a color component and an index component; and
separately stream color components and index components for a plurality of compressed blocks of color data for lossless encoding.

13. The processing system of claim 10, wherein the at least one processor is further configured to:
indicate at a header of each compressed block of color data the block compression format that was used to compress the color data and an algorithm used to convert the block of neural network data into a block of color data.

14. The processing system of claim 10, wherein each block of the plurality of blocks comprises a two-dimensional array of elements.

15. The processing system of claim 14, wherein the at least one processor is further configured to:
selectively pad each two-dimensional array of elements to generate two-dimensional arrays of elements that are divisible by 4×4 elements.

16. The processing system of claim 10, wherein the at least one processor is further configured to:
specify a quality factor to limit a quantization loss associated with compressing the neural network data.

17. The processing system of claim 16, wherein the at least one processor is further configured to:
select, based on the quality factor, at least one of a quantization algorithm for converting a floating-point value of neural network data to a color value and the block compression format.

18. A non-transitory computer readable medium embodying a set of executable instructions, the set of executable instructions to manipulate at least one processor to:
group neural network data into a plurality of blocks;
convert the blocks of neural network data into blocks of color data; and
compress the blocks of color data using block compression for storage at a memory.

19. The non-transitory computer readable medium of claim 18, wherein the set of executable instructions to manipulate the at least one processor to:
divide each compressed block of color data into a color component and an index component; and
separately stream color components and index components for a plurality of compressed blocks of color data for lossless encoding.

20. The non-transitory computer readable medium of claim 18, wherein the set of executable instructions to manipulate the at least one processor to:
indicate at a header of each compressed block of color data a block compression format that was used to compress the color data and a quantization algorithm used to convert the block of neural network data into a block of color data.

21. The non-transitory computer readable medium of claim 18, wherein each block of the plurality of blocks comprises a two-dimensional array of elements.
